(19) United States
(12) Patent Application Publication
(10) Pub. No.: US 2006/0235949 A1
(43) Pub. Date: Oct. 19, 2006

(54) Firmware update method for automatically updating firmware of a plurality of electronic devices and network thereof

(76) Inventors: Ta-Wen Tai, Hsin-Chu City (TW); Chien-Chung Tai, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/907,779

(22) Filed: Apr. 15, 2005

(51) Int. Cl. G06F 15/16

(52) U.S. Cl. 709/219

(57) ABSTRACT

A firmware update method used in a network. The network includes a firmware server, an update initiator, and a plurality of electronic devices. The method includes the following steps: transmitting an update initiating command from the update initiator to each of the electronic devices; transmitting a firmware update request from each of the electronic devices to the firmware server in response to the update initiating command; transmitting an update code from the firmware server to each of the electronic devices in response to the firmware update request; and updating firmware of each of the electronic devices with the update code.

### BACKGROUND OF INVENTION

1. Field of the Invention

The present invention relates to firmware updates, and more particularly, to a firmware update method for automatically updating firmware of a plurality of electronic devices, and a network thereof.

2. Description of the Prior Art

With developing technology, there are more and more electronic devices being proposed which make daily life become more convenient. A storage device (such as a memory) is usually set in an electronic device for storing firmware, which is an executable code and associated data that control the operation of the electronic device.

Firmware of an electronic device sometimes needs to be updated. For example, some possible reasons for firmware updating are “bugs exist in original firmware of the electronic device” and “there is a new version of firmware proposed for the electronic device”. Regardless of what reason is, firmware updating is always a time consuming job.

Rather than being updated by a user, firmware of an electronic device is always updated by the manufacturer of the electronic device. After the users disassemble the electronic devices and return them to the manufacturer, the engineers of the manufacturer manually update firmware of the electronic devices one by one. With more electronic devices having firmware update requirements, more time is consumed in the firmware update process.

### SUMMARY OF INVENTION

It is an objective of the claimed invention to provide a firmware update method for automatically updating firmware of a plurality of electronic devices, and a network thereof.

According to the claimed invention, a firmware update method used in a network is disclosed. The network comprises a firmware server, an update initiator, and a plurality of electronic devices. The method includes transmitting an update initiating command from the update initiator to each of the electronic devices, transmitting a firmware update request from each of the electronic devices to the firmware server in response to the update initiating command, transmitting an update code from the firmware server to each of the electronic devices in response to the firmware update request, and updating firmware of each of the electronic devices with the update code.

According to the claimed invention, a network for updating firmware is disclosed. The network includes an update initiator for transmitting an update initiating command; a plurality of electronic devices coupled to the update initiator, each of the electronic devices for receiving the update initiating command from the update initiator and transmitting a firmware update request in response to the update initiating command; and a firmware server coupled to the electronic devices, for receiving the firmware update request from each of the electronic devices and transmitting an update code to each of the electronic devices in response to the firmware update request. Each of the electronic devices updates its firmware with the received update code.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a network for firmware updating according to an embodiment of the present invention.

### DETAILED DESCRIPTION

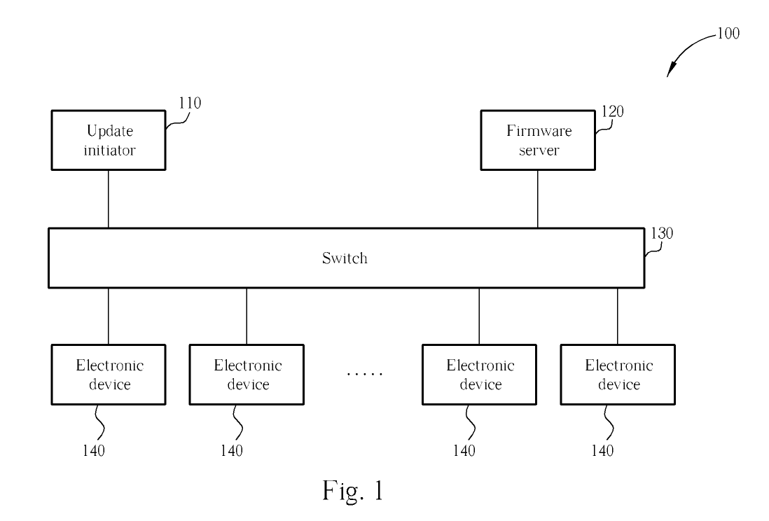

Please refer to FIG. 1, which is a block diagram of a network for firmware updating according to an embodiment of the present invention. In this embodiment, the network 100 is a local area network (LAN), which includes an update initiator 110, a firmware server 120, a switch 130, and a plurality of electronic devices 140. The switch 130 can also be a hub and interconnects the update initiator 110 and the firmware server 120 with the electronic devices 140. Please note that the update initiator 110 and the firmware server 120 are just two functional blocks, a single hardware device can also be used to implement these two functional blocks. The electronic devices 140 are devices that need firmware updating. Each of the electronic devices 140 can be a newly manufactured device or a previously sold device returned for firmware updating. If some of the electronic devices 140 are newly manufactured devices not embedded with unique media access control (MAC) addresses, a random MAC technology can be utilized. With the random MAC technology, each of the electronic devices 140 can have a unique MAC address, and addresses collision will not become a problem.

With the idea of the present invention, firmware of each of the electronic devices 140 is updated simultaneously. First, the update initiator 110 transmits an update initiating command to each of the electronic devices 140. In one example, the update initiator 110 multicasts the update initiating command to the electronic devices 140. In another example, the update initiator 110 broadcasts the update initiating command to the electronic devices 140. Sometimes, switches are designed to discard ordinary broadcast packets rather than really “broadcast” them. If the update initiating command is broadcasted to the electronic devices 140, to make sure it is indeed received by all of the electronic devices 140, an address resolution protocol (ARP) can be used. In other words, since ARP packets are certainly “broadcasted”, the update initiator 110 can embed the update initiating command into the payload part of an ARP request packet and broadcast the ARP request packet to the electronic devices 140.

Next, after each of the electronic devices 140 receives the update initiating command, each of the electronic devices 140 transmits a firmware update request to the firmware server 120 in response to the update initiating command. Then, the firmware server 120 transmits an update code to each of the electronic devices 140 in response to the firmware update request. Before communication between the firmware server 120 and each of the electronic devices 140 is established, it is possible that the address of the firmware server 120 remains unknown information to each of the electronic devices 140. Fortunately, the firmware server 120 and each of the electronic devices 140 can perform the above-mentioned steps (including the step of transmitting the firmware update request and the step of transmitting the update code) according to one of several feasible network protocols. For example, the firmware server 120 and each of the electronic devices 140 can perform the steps according to a bootstrap protocol (BOOTP). According the bootstrap protocol, each of the electronic devices 140 can determine an IP address of the firmware server 120 and the firmware server 120 can assign an IP address to each of the electronic devices 140. Furthermore, the file name of the update code to be transmitted to each of the electronic devices 140 can also be determined. In addition, to save network bandwidth, the firmware server 120 can multicast the update code to the electronic devices 140 rather than unicast the update code to each of the electronic devices 140.

After each of the electronic devices 140 receives the update code, each of the electronic devices 140 updates its firmware with the update code. Firmware updating of the electronic devices 140 is then finished. To indicate that an electronic device 140 has accomplished the firmware update process, the electronic device 140 can enter a wait mode and notify the engineers through some means, such as through a blinking LED, or through a beep voice, etc. The engineers can then remove the firmware updated electronic device 140 from the network 100. Since the update initiator 110 can send out update initiating commands intermittently, other electronic devices 140 demanding a firmware update can be plugged into the network 100 at any moment. When the electronic devices 140 receive an update initiating command, the electronic devices 140 remaining in or already finished with the firmware update process can discard the update initiating command while the electronic devices 140 newly attached to the network 100 and not yet entered the firmware update process can start the firmware update process in response to the update initiating command.

Please note that the network 100 being a local area network is just an example. The update initiator 110, the firmware server 120, and the electronic devices 140 can also be functional blocks located in several different network domains interconnected by routers. In other words, the update initiator 110, the firmware server 120, and the electronic devices 140 can be functional blocks scattered around the Internet. Since broadcast packets cannot penetrate a router connecting two different network domains, broadcast becomes an inappropriate means for transmitting the above-mentioned update initiating command, firmware update request, and the update code. Under this circumstance, multicast and unicast become more suitable means for transmitting the update initiating command, firmware update request, and the update code. Moreover, even through the network 100 shown in FIG. 1 is a wired local area network, the network of the present invention can also be a wireless network.

In contrast to the prior art, the overall firmware update process of the present invention is an efficient and expeditious process. Firmware of a plurality of electronic devices can be swiftly updated all at once. Moreover, the firmware update process is performed automatically. Except for the physical plug-in and physical remove operations, no more manual operation is required.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware update method used in a network, the network comprising a firmware server, an update initiator, and a plurality of electronic devices, the method comprising:
transmitting an update initiating command from the update initiator to each of the electronic devices;
transmitting a firmware update request from each of the electronic devices to the firmware server in response to the update initiating command;
transmitting an update code from the firmware server to each of the electronic devices in response to the firmware update request; and
updating firmware of each of the electronic devices with the update code.

2. The firmware update method of claim 1, wherein the step of transmitting the update initiating command comprises:
broadcasting the update initiating command to the electronic devices.

3. The firmware update method of claim 1, wherein the step of transmitting the update initiating command comprises:
broadcasting the update initiating command to the electronic devices according to an address resolution protocol (ARP).

4. The firmware update method of claim 1, wherein the step of transmitting the update initiating command comprises:
multicasting the update initiating command to the electronic devices.

5. The firmware update method of claim 1, wherein the step of transmitting the update code comprises:
unicasting the update code to each of the electronic devices.

6. The firmware update method of claim 1, wherein the step of transmitting the update code comprises:
multicasting the update code to the electronic devices.

7. The firmware update method of claim 1, wherein the step of transmitting the firmware update request and the step of transmitting the update code are performed according to a bootstrap protocol (BOOTP).

8. A network for updating firmware, the network comprising:
an update initiator for transmitting an update initiating command;
a plurality of electronic devices coupled to the update initiator, each of the electronic devices being for receiving the update initiating command from the update initiator and transmitting a firmware update request in response to the update initiating command; and
a firmware server coupled to the electronic devices, for receiving the firmware update request from each of the electronic devices and transmitting an update code to each of the electronic devices in response to the firmware update request;
wherein each of the electronic devices updates its firmware with the update code.

9. The network of claim 8, wherein the update initiator broadcasts the update initiating command to the electronic devices.

10. The network of claim 9, wherein the update initiator broadcasts the update initiating command to the electronic devices according to an address resolution protocol (ARP).

11. The network of claim 8, wherein the update initiator multicasts the update initiating command to the electronic devices.

12. The network of claim 8, wherein the firmware server unicasts the update code to each of the electronic devices.

13. The network of claim 8, wherein the firmware server multicasts the update code to the electronic devices.

14. The network of claim 8, wherein each of the electronic devices communicates with the firmware server according to a bootstrap protocol (BOOTP).

15. A firmware update method used in a network, the network comprising a firmware server, an update initiator, and an electronic device, the method comprising:
transmitting an update initiating command from the update initiator to the electronic device;
transmitting a firmware update request from the electronic device to the firmware server in response to the update initiating command;
transmitting an update code from the firmware server to the electronic device; and
updating firmware of the electronic device with the update code.

16. The firmware update method of claim 15, wherein the step of transmitting the update initiating command comprises:
transmitting the update initiating command to the electronic device according to an address resolution protocol (ARP).

17. The firmware update method of claim 15, wherein the step of transmitting the update code comprises:
unicasting the update code to the electronic device.

18. The firmware update method of claim 15, wherein the step of transmitting the firmware update request and the step of transmitting the update code are performed according to a bootstrap protocol (BOOTP).
